(19) United States
(12) Patent Application Publication
(10) Pub. No.: US 2022/0141424 A1
(43) Pub. Date: May 5, 2022

(54) SYSTEM AND METHOD FOR IMAGE DETECTION OF PESTS

(71) Applicant: Gary B. Levin, Karnei Shomron (IL)

(72) Inventor: Gary B. Levin, Karnei Shomron (IL)

(21) Appl. No.: 17/500,959

(22) Filed: Oct. 14, 2021

Related U.S. Application Data
(60) Provisional application No. 63/109,361, filed on Nov. 4, 2020.

(51) Int. Cl. H04N 7/18; H04N 13/239; G06K 9/00; G08B 7/06; G08B 25/10

(52) U.S. Cl. CPC H04N 7/18; H04N 13/239; G08B 25/10; G08B 7/06; G06K 9/00362

(57) ABSTRACT

A stereoscopic imaging apparatus to capture pest images. The apparatus comprises stereoscopic sensors to capture pest images and an image processing code operative to process the pest image. An image processor and hardware control unit stores and runs a program instruction code and the image processing code. The program instruction code runs interface drivers to communicate with the stereoscopic sensors, hardware interface circuits, and has an alarm notification operation to generate a pest removal action from a property.

### REFERENCE TO PRIORITY APPLICATION

U.S. provisional Patent Application No. 63/109,361 filed Nov. 4, 2020, entitled, “SYSTEM AND METHOD FOR IMAGE DETECTION OF PESTS,” (Attorney Docket No 102).

### FIELD OF THE DISCLOSURE

The present invention relates generally to a system and methods of stereoscopic imaging, pest detection, notification, networking, and pest control treatment thereof.

### BACKGROUND OF THE INVENTION

Pests, both venomous and non-venomous pose a health and safety risk to the public. My own personal and terrifying encounter with a scorpion occurred when one scorpion crawled inside a shirt draped over a chair, and in turn when I dressed, made skin contact on my back. This was a very frightening experience and fortunately, I was not stung. These and other nasty encounters with various pests motivated me to create a solution to these threats. That solution is an apparatus and methods for three-dimensional stereoscopic detection of pests, providing pest status for a property recorded, displayed and external communications for pest control removal thereof.

### SUMMARY OF THE INVENTION

According to a first aspect, the present invention provides an apparatus, comprising a stereoscopic imaging unit (SIU) to capture a stereo image on a property, an image processing code to process the stereo image, an image processor and hardware control unit (IPHWCU) to store and run an image processing code to process the stereo image, a program instruction code operative to run the IPHWCU and host the image processing code, wherein the program instruction code provides hardware circuit interfaces drivers to communicate with the SIU and other interface circuits, a non-volatile memory configured to store the stereo image, a physical transmission media operative to couple with the SIU on a first distal end and operative to couple with the at least one IPHWCU on a second distal end for transmitting venomous a stereo image, a bus protocol communicative to couple the SIU on a first distal end and communicative to couple the IPHWCU on a second distal end wherein the IPHWCU program instruction code comprises a driver(s) to transmit a stereo image via an imaging interface circuit, a camera flash lighting device operative to couple with said stereoscopic imaging unit SIU for illuminating the venomous pest, a power supply circuitry supplying direct-current (DC) voltage from a battery operative to power said apparatus; and an alarm operative to generate a pest removal action from the property.

Embodiments of the invention can include one or more of the following features. The pest removal action can be a professional pest exterminator and pest removal service. The pest can be a venomous pest selected from the group comprising snakes, spiders, and scorpions. The pest can be a non-venomous. The apparatus can further comprise a 5G radio frequency (RF) communications unit coupled with the at least one image processor and hardware control unit and operative to communicate with an external network for alarm notification. The apparatus can further comprise a movable mounting mechanism to aim the stereoscopic imaging unit towards regions of interest on the property. The property can be from a group comprising a residential unit, restaurant, tent, campground, RV unit, office space, hospital, and a hotel. The apparatus can further comprise an annunciator for announcing selected from a group of audible devices, The annunciator can comprise a visual device selected from a group comprising a semiconductor device, an incandescent lamp or fluorescent lamp. The visual device can be a visible light, emitter adapted for a steady illumination and for blinking. The apparatus can further comprise an operating temperature range substantially between −40° C. to 125° C. The apparatus can further comprise a system IP67 compliance rating for outdoor operation and water resistance. The apparatus can further comprise a system IP68 compliance rating for outdoor operation and water resistance. The apparatus can also provide email status and alerts, as well as SMS status and alerts to digital devices.

According to another aspect, the present invention provides a method of imaging and detecting pests on a property comprising the steps of capturing a stereo image, processing the stereo image, detecting a pest in the stereo image, identifying the pest in the stereo image, and generating an alarm to create a service call for removal of the pest from a property.

Further embodiments of the method can include one or more of the following features. The property can be a restaurant, and the detection is for safety and health compliance. The property can be residential, and the pest can be venomous. The property can be a camp-ground and the pest can be venomous. The property can be a hotel, and the detection prevents against legal actions from guests against the hotel. The property can be residential, and the pest can be non-venomous.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled.

### BRIEF DESCRIPTION OF THE DRAWINGS

The figures illustrate various objects and features. Some objects or features can be exaggerated to show details of components where the drawings are not to scale. Any measurements or specifications shown in the figures are illustrative and are not restrictive. Figures can show corresponding elements by repeating reference numbers and numerals. The accompanying drawings describe various examples.

FIG. 1 is a high-level block diagram illustrating a stereoscopic imaging unit, an image processor and hardware control unit, a display, and a communications infrastructure.

FIG. 2 is a high-level block diagram illustrating a plurality of communications infrastructures, an image processor and control, a direct current power supply and a display,

FIG. 3 is a high-level block diagram illustrating stereoscopic imaging unit components thereof.

FIG. 4 is a high-level block diagram illustrating example integration of stereoscopic imaging unit and image processing and hardware control unit,

FIG. 5 is a diagram illustrating a perspective view of the stereophonic pest detection system.

FIG. 6 is a flow diagram illustrating an example pixel-by-pixel algorithm for defect detection.

FIG. 7 is a flow diagram for cascade classifier training utilizing OpenCV for defect detection.

FIG. 8 is a high-level block diagram illustrating example image processing and hardware control unit components thereof.

FIG. 9 is a flow diagram illustrating object detection.

FIG. 10 is a diagram showing a camera calibration.

### DETAILED DESCRIPTION

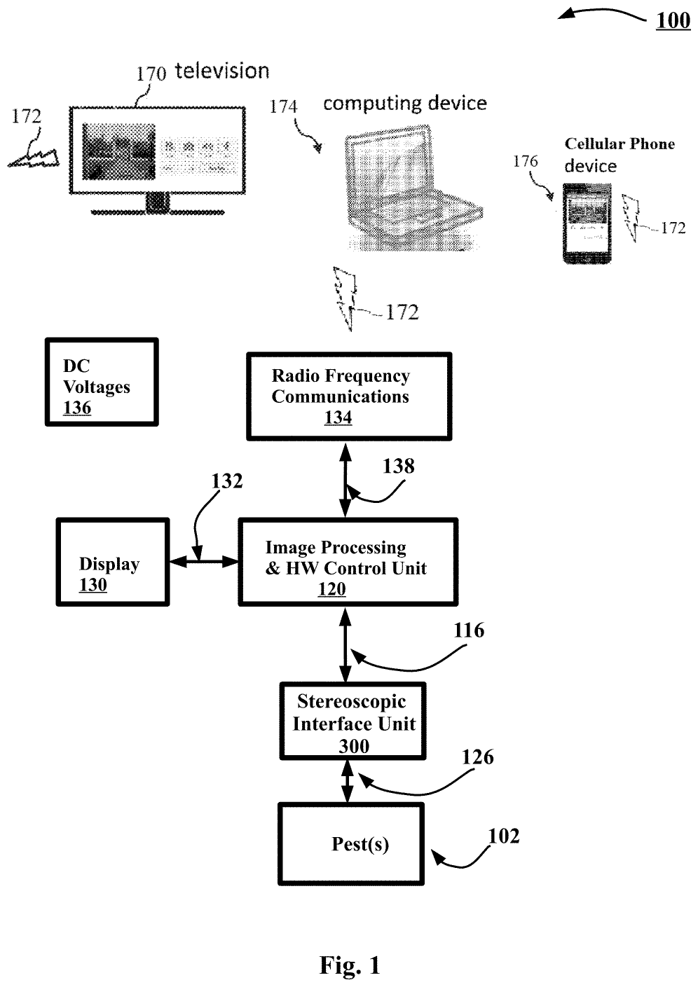

Referring now to FIG. 1, a high-level block diagram illustrates a stereoscopic imaging unit (SIU), an image processor and hardware control unit (IPHWCU), a display and a communications infrastructure. Each SIU 300 is operative to capture at least one three-dimensional pest image pair. SIU 300 couples to the pest(s) 102 by a field of view (FOV) 126 parameter determined by the required optics.

System 100 further comprises one or more IPHWCU 120 providing image processing resources and the memory required to analyze the captured image pairs. IPHWCU receives image pairs for processing and inspects the image pairs for pest detection. The system 100 further comprises an optional display 130, direct current voltages 136 and a Radio frequency communications unit 134. In some aspects, the system 100 can further comprise one or more of the following devices: (1) wireless communication link 172; (2) television 170; (3) computing device 174; (5) cellular phone device 176, (6) pest(s) 102; (7) image sensors 110; (8) a first physical transmission media 116; (9) display interface bus 132; (10) and (11) a third physical transmission media 138. In some other aspects, the system does not include a display 130 physically interfacing to the IPHWCU 120, but has display capability on a cellular phone device 176, a television 170, a computing device 174, and such like mobile devices. The pests 102 are not part of the system installed, but part of the system for purposes of detection and identification. The apparatus described in system 100 may constitute a component of a Smart Home.

The first physical transmission media 116 interfaces the IPHWCU 120 to the SIU 300. A second physical transmission media is the display interface bus 132 which interfaces IPHWCU 120 to the display 130. The third physical transmission media 138 interfaces the IPHWCU 120 to the Radio frequency communications unit 134.

Each of the first physical transmission media 116, the display interface bus 132, and the third physical transmission media 138, selects from at least one member of a physical transmission media group comprising: (1) single wire; (2) parallel bus; (3) at least one twisted-pair; (4) fiber-optic; (5) IEEE 1394; (6) or MIL-STD-1773. The physical transmission media are operative to couple with one or more SIU 300 on a first distal end and operative to couple with the at least one IPHWCU 120 on a second distal end. An IPHWCU 120 is operative to couple to the display 130 on a third distal end and communicative to couple with a Radio frequency communications unit 134 on a fourth distal end.

One or more bus protocols is operative to communicate and couple with the first physical transmission media 116, display interface bus 132, and a third physical transmission media 138. The bus protocol selection is related to a physical transmission media group. The bus protocol is communicative to couple with the one or more SIU 300 on a first distal end and communicative to couple with one or more IPHWCU 120 on a second distal end, communicative to couple with a display 130 on a third distal end, communicative to couple with a Radio frequency communications unit 134 on a fourth distal end.

A bus protocol can comprise one of the following protocols: A²B, AFDX, ARINC 429, Bluetooth, Byteflight, Controller Area Network (CAN), Cortex AHB. Cortex APB, Cortex AHX, D2B, FlexRay, BUS [2], IDB-1394, IEBus, Inter-Integrated Circuit (I²C), ISO 9141-1/-2, J1708 and J1587, J1850, J1939, ISO 11783, J1939, ISO 11783, Keyword Protocol 2000, Local Interconnect Network (LIN), MOST, Multi-Function Bus, simple parallel bus protocol, Train Communication Network IEC 61375, Serial Peripheral Interface (SPI), SMARTWIREX, VAN, HDBaseT automotive protocols, power-line communication, and Universal Serial Bus (USB).

A power supply circuit operative to output direct-current, direct current voltages 136 to system electronics meeting all operating voltage levels system requirements. In one case, the input to the power supply circuit is operative to couple with alternating current (AC) voltages ranging from substantially 110 volts to substantially 240 volts at a 50 or 60 hertz frequency. An alternating current (AC) to direct-current (DC) transformer, diode bridge and smoothing capacitors rectifies the AC voltage to produce a DC voltage. In an alternative case, the DC voltages are powered from a battery. In some aspects, the power supply circuit can comprise direct-current battery voltage to direct-current switching step-up circuitry and/or step-down circuitry from the input voltage. Other power supply circuits can comprise linear voltage regulators, Schottky diodes, and resistive voltage dividers.

An optional display 130 is communicative to couple the display interface bus 132 with at least one or more IPHWCU. In one case, the display 130 comprises one or more visual indicator. Example visual indicators can come from a group comprising: (1) Light-Emitting Diode (LED); (2) incandescent lamp; (3) fluorescent lamp; (4) Active Matrix Organic Light-Emitting Diode (AMOLED); (5) In Plane Switching displays; or (6) LCD screen. The visual indicator can be steady, blinking, and can further be used to illuminate a part of the dashboard.

In one case, the Radio frequency communications unit 134 can transmit pest status via a wireless communication link 172 to a television 170, a computing device 174, and a cellular phone device 176 which also can also be a computing device. In a further case, transmission of pest status information can use radio, WIFI, 3G, 4G or 5G cellular circuit technologies, wideband code division multiple access (WCDMA), and/or worldwide interoperability for microwave access (WIMAX) as shown in Radio frequency communications unit 134. Bluetooth In one case, transmitting pest status information can use a universal serial bus USB.

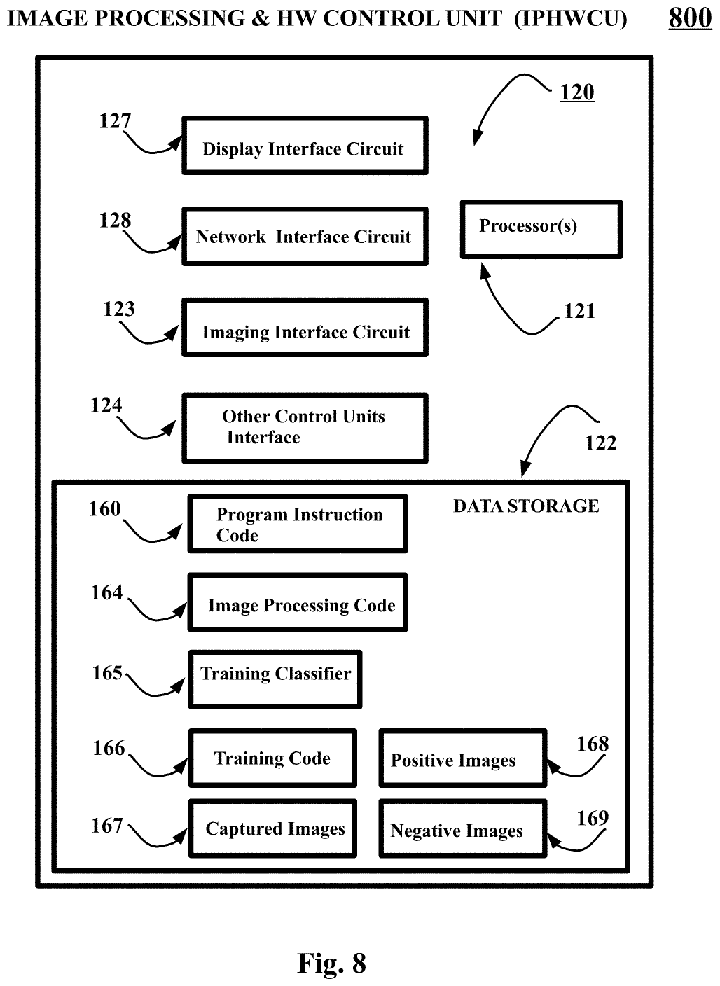

Referring to FIG. 8, a high-level diagram 800 illustrates example image processing and hardware control unit components thereof. The computer-readable program instruction code can execute in whole or in part on an IPHWCU 120. In one aspect of the design, processor(s) 121 execute the computer-readable program instruction code by using state information of the computer-readable program instruction code to personalize the electronic circuitry. The IPHWCU 120 comprises a display interface circuit 127, network interface circuit 128, imaging interface circuit 123 and other control units interface 124. The IPHWCU 120 architecture can be homogenous or heterogeneous for parallel processing, as clusters, and/or as one or more multi-core processor(s). The data storage 122 can include one or more non-transitory persistent storage devices, for example, a hard drive disk (HDD), a Solid-State Disk (SSD), a flash array for the storage of program instruction code 160, image processing code 164, training classifiers 165, training code 166, captured image pairs 167, positive images 168, negative images 169, and other data required. Data storage 122 can further include one or more networked storage resources accessible over the network(s) through the network interface circuit 128 to a network-attached storage (NAS), a storage server, or cloud storage. The system can use one or more volatile memory devices for temporary storage of program instruction code 160, image processing code 164, training classifiers 165 training code 166, and/or data. An IPHWCU 120 can execute one or more software modules, for example, a process, a script, an application, an agent, a utility. Software module execution comprises a plurality of program instruction code, stored in a non-transitory medium. In one case, the IPHWCU 120 can include and/or integrate an radio frequency communications unit 134.

The program instruction code 160 can host a software operating system running Unix, Linux, Android, Windows, and/or other embedded operating systems. The image processing code 164, training classifiers 165, training code 166, positive images 168, and negative images 169 is operational to run on these operating systems.

Code is a plurality of computer-executable instructions grouped into program modules executed by the computer. A program module comprising routines, programs, objects, components, data structures to perform particular tasks or implement particular abstract data types. In one case, distribution of the code on computing environments performs tasks by remote processing devices linked through a communications network. In a distributed computing environment, program modules can be in both local and remote computer storage media, including memory storage devices.

Data storage 122 is any combination of one or more computer-usable or computer-readable medium(s) is possible. The computer-usable or computer-readable medium can be, for example, but not limited to, an electronic, magnetic, optical, electromagnetic, infrared, or semiconductor system, apparatus, device, or propagation medium. More specific examples comprising a computer-readable medium includes: an electrical connection having one or more wires, a portable computer diskette, a hard disk, a random access memory (RAM), a static random access memory (SRAM), a dynamic random access memory, Synchronous dynamic random access memory (SDRAM), Double-Data-Rate SDRAM (DDR SDRAM), a read-only memory (ROM), an erasable programmable read-only memory (EPROM or flash memory), an USB memory device, a portable compact disk, a read-only memory (CD-ROM), an optical storage device. A computer-usable or computer-readable medium can be any medium that can contain or store the program for use by or with the instruction execution system, apparatus, or device. A computer-readable medium is not in the category of transitory signals, such as radio waves or other propagating electromagnetic waves, electromagnetic waves propagating through a waveguide,

Computing/processing devices loads, or mounts a program instruction code 160 from a computer-readable storage medium for data storage 122. The computer-readable storage medium for data storage 122 can be an external computer. The computer-readable storage medium can be an external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer-readable program instruction code from the network and forwards the computer-readable program instructions for storage in a computer-readable storage medium within the respective computing/processing device.

Computer program instruction code for carrying out operations can be in any combination of one or more programming languages, including object-oriented programming language such as Java, C++, C#, or procedural programming languages, such as the “C” programming language, and functional programming languages such as Prolog, Perl, and Python, machine code, assembler, image processing languages or scripts such as openCV, machine learning languages or programs such as Python, R, Matlab, Go, Julia, machine learning tools such as TensorFlow, PyTorch, Sci-kit Learn, Keras, or any other suitable programming languages.

Program instruction code can execute in whole or in part as a stand-alone software package on the user's computer, a remote computer or server. Remote computer(s) can connect to the user's computer using a Radio frequency communications unit 134 and to the IPHWCU via the network interface circuit 128 using any network protocol, including for example a local area network (LAN) or a wide area network (WAN), WLAN, WCDMA, WiMAX or can connect to an external computer for example, through the Internet using an Internet Service Provider.

Computing device, referred to as a processor(s) 121, is operational with general-purpose, special-purpose and image processing computing system environments or configurations. Examples of computing systems, environments, and/or configurations that can be suitable for use can comprise personal computers, server computers, cloud computing, hand-held or laptop devices, multiprocessor systems, microprocessor, micro-controller or microcomputer-based systems, application-specific integrated circuit (ASIC) or field-programmable gate array (FPGA) cores, digital signal processing (DSP) cores, Cortex-A8 processing core(s), Brisbane processing core(s), neural network (NN) processors, convolutional neural network processors, (CNN), graphics and image processing integrated circuits and boards, single-board computer (SBC), graphics processing unit (GPU), Nvidia graphics board, Goya Inference Processor, Qualcomm processors, Rockchip RK1808 neural network processing units, Hailo neural network processors, Habana Labs neural network processors, Intel neural network processors, PCIe cards, Raspberry Pi boards, Arduino boards, Beagle boards, network PCs, minicomputers, distributed computing environments that include any of the above systems or devices.

In some cases, data storage 122 can save pest detection and identification results in non-volatile memory. Pest detection and identification results can couple to a display 130 via a display interface circuit 127. The IPHWCU 120 can trigger other indicators warning of threatening conditions derived from pest detection results. The threats can be life-threatening, capable of causing fear or distress from the perceived spread of disease.

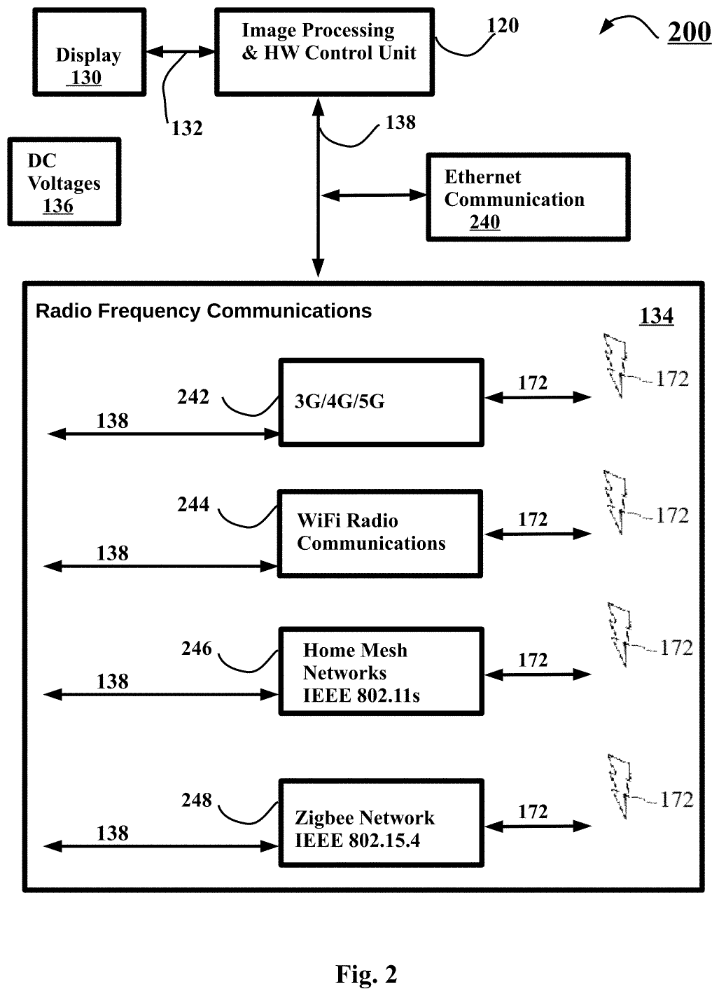

Referring back to FIG. 2, the system 200 can further comprise at least one of the following communications unit: a hard-wired Ethernet cabling 240, Radio frequency communications unit comprising cellular communications standards 3G/4G/5G 242, a WiFi communications 244 according to the IEEE 802.11s standard for a Home Mesh Network 246, and a Zigbee IEEE 802.15.4 Network 248. The wireless communication link 172 connects the blocks to a television 170, computing device 174, and a cellular phone device 176. The wireless communication link 172 is according to the standards of the block chosen. Sometimes a PCIe add-on card interfaces the computing device 174 to connect to 244, 246 and 248. The apparatus described in system 200 may constitute a component of a Smart Home whose wireless interfaces are described.

An example ESP8266 Wi-Fi Module is a self-contained System on Chip (SoC) with built in firmware support. The ESP8266 Wi-Fi Module has an integrated TCP/IP protocol stack supporting a Wi-Fi network communication link. In one example, a Home Mesh Network 246 can comprise one or more Xbee devices. An example Zigbee IEEE 802.15.4 Network comprises a radio module. Zigbee IEEE 802.15.4 manufacturers and radio modules include: Anaren A2530x24x devices: Atmel ZigBit ATZB-24-xx devices: California Eastern Laboratories ZICM357SP02, ZICM357SP2 and ZICM3588SP0 devices: Dresden Eltronik: Kirale Technologies: MMB Networks: NXP: Control Data Systems: Panasonic: Radiocrafts: RF Monolithics: Sena Technologies: and Telegesis Ltd.

The electronic components comprising all the systems have an operational temperature range selected from a group specified as: (1) industrial: −40° C. to 85° C.; (2) automotive: −40° C. to 125° C.; (3) extended industrial; −40° C. to 85° C.; or (4) military: −55° C. to 125° C. In one case, the system is IP67 compliant for outdoor operation and water resistance. In another implementation, a system is IP68 compliant system for outdoor operation and water resistance.

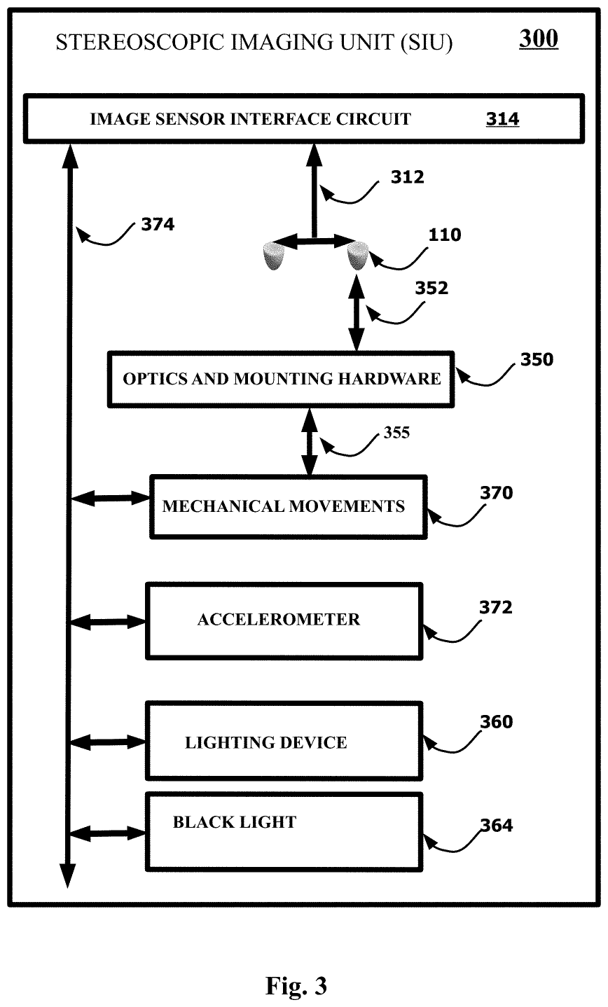

Referring now to FIG. 3, a high-level block diagram illustrates a stereoscopic imaging unit. SIU 300 comprises image sensors 110 or cameras and associated optics and mechanical mounting hardware 350, a stereo image sensor or camera interface 312 and a stereo image sensor interface circuit or image sensor interface circuit 314 operative to couple with one or more IPHWCU 120 via a first physical transmission media 116. A lighting device 360 couples to image sensor interface circuit 314 via bus 374. In one aspect, a mechanical movement 370 is operative to aim the stereo image sensor via commands over the bus 374. The optics and mechanical mounting hardware 350 will support guiding the stereo vision system using mechanical movement 370 to capture pest image pairs. In one case, a mechanical movement 370 can couple to an optional accelerometer 372.

The SIU 300 is a stereo camera unit comprising image sensors and stereo vision interface circuitry. In one case, the image sensor interface circuit 314 can comprise an intellectual property (IP) core for an FPGA. After testing and system verification, an FPGA to ASIC conversion provides an alternative for a mass production and lower costs. In another aspect of the design, SIU 300 uses a design kit such as the Raspberry Pi and Arducam project depth mapping on Arducam stereo camera HAT with OpenCV using the OV5647 stereo camera board. Present Nerian Vision Technologies stereo vision modules with real-time streaming are too expensive. According to another aspect of SIU 300, it can use the FPGA technology of Karmin 3D Stereo Camera. In another case, a SIU 300 can include a modification of the Dan Strother verilog based FPGA stereo core project, available under a 3-clause BSD license. A drawback of off-the-shelf (OTS) stereo camera products is the high cost of real-time streaming. A low-cost solution is desirable and attainable by removing the real-time video streaming support. Removal of 4K real-time video streaming lowers the overall hardware silicon area, reducing the total hardware costs. Removing 4K real-time video streaming can require changes in silicon or in the verilog or vhdl source code for programmable integrated circuits.

In some implementations, the SIU can create a stereo image by capturing an image pair from each of the two image sensor/cameras. The image pair comprises a right-sided image, and a left-sided image. A right-sided image, and a left-sided image combine in the SIU to create a stereo image, also known as stereo vision. SIU transfers the stereo image to the at least one IPHWCU for image processing, defect recognition, and character recognition. The phrase “stereo image” also refers to a three-dimensional image pair.

The image sensors, 110 can comprise CMOS or sCMOS image sensors. Technological advances do not prevent using other image sensors. The internal image sensor has a camera interface 312 can comprise: (1) a parallel signal bus; (2) MIPI alliance camera serial interfaces (CSI); (3) MIPI CSI-2; (4) PCIe; or (5) other differential signal bus. The stereo image sensor or image sensor interface circuit 314 comprises electronic circuitry operative and communicative to couple with image sensor components between various system blocks. The image sensor interface circuit 314 can include a micro-controller, FPGA or other embedded devices for interfacing electronics.

In one example, an optics and mechanical mounting hardware 350 couples uses an optical-coupling 352 to the image sensors 110 for image capture and focus enhancements. The optics comprises lens and mounting hardware for three-dimensional image capture. According to some examples, the optics and mechanical mounting hardware 350 couples by mechanical coupling hardware 355 to mechanical movements 370, allowing the positioning and aiming of the image sensors. The optics and mechanical mounting hardware 350 can couple to a mechanical movement 370 comprising an epicyclic train allowing for adjusting the angular image capture of the pests. Another example of a mechanical movement 370 example uses a rectilinear slide motion, whereby a screw guides the image sensors 110 to a more favorable FOV position. A further mechanical movement 370 example uses a wheel to produce rotary motion from the circular motion of a screw to guide the image sensors. According to another aspect of the examples, a stepper motor or a direct-current motor enables and controls the mechanical movement 370. The at least one IPHWCU 120 and/or an embedded application using a micro-controller in the SIU can provide control and signaling commands over bus 374 to the movement motors via the image sensor interface circuit 314. The mechanical movement 370 can include an optic lens cover to protect the optics from dirt, grease, filth, and grime. Here, the lens cover is closed by default and opens to expose the optics during image capture. It is possible that the lens covers can open for substantially the time to capture image pairs. The SIU 300 includes a plurality of two or more image sensors. The SIU can include two, three, four, five, six or more image sensors.

SIU 300 can include a lighting device 360 for illuminating the pest during image capture and is operative to couple with the SIU 300. Camera lighting devices can be a flash bulb, a Led flash, or an infrared light. In some cases, lighting device 360 can include local-plane-shutter synchronization, flash intensity, and flash duration. Lighting can be steady or blinking or flash. Image sensor interface circuit 314 provides signals to control the lighting device. In one alternative example, the SIU 300 includes a black light 364, known as an ultra-violet light for detecting the fluorescent properties of scorpions, wherein said black light 364 is in parallel with image processing and a lighting device 360 for reducing false positives.

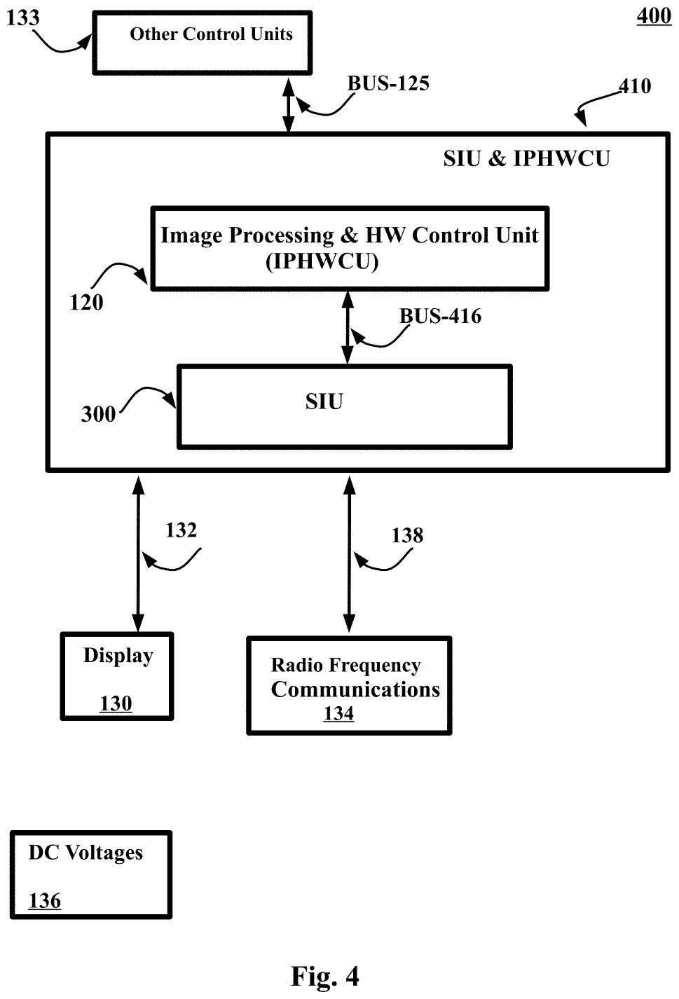

FIG. 4 shows a high-level block diagram 400 illustrating example integration of a stereoscopic imaging unit and image processing and hardware control unit (SIU & IPHWCU). In one case, SIU 300 couples via bus 416 to one or more IPHWCU 120 and integrate to become the SIU & IPHWCU 410 to provide a self-contained unit. SIU & IPHWCU 410 interfaces to system device either in a point-to-point configuration or in a daisy chain configuration. Display 130 couples to the SIU & IPHWCU via the display interface bus 132. Radio frequency communications unit 134 couples to the SIU & IPHWCU 410 via the third physical transmission media 138. Direct current voltages 136 supplies voltages to all electronics throughout the system. In some cases, bus 125 couples other control units 133 to the SIU & IPHWCU 410

The SIU 300 can conform to an IP67 outdoors environmental specification which offers protection against dust, water damage, and dirt. In another case, the SIU 300 can conform to the IP68 outdoors specification against dust, dirt, and water damage to protect the optics. These specifications protect the electronics and optics against environmental damage.

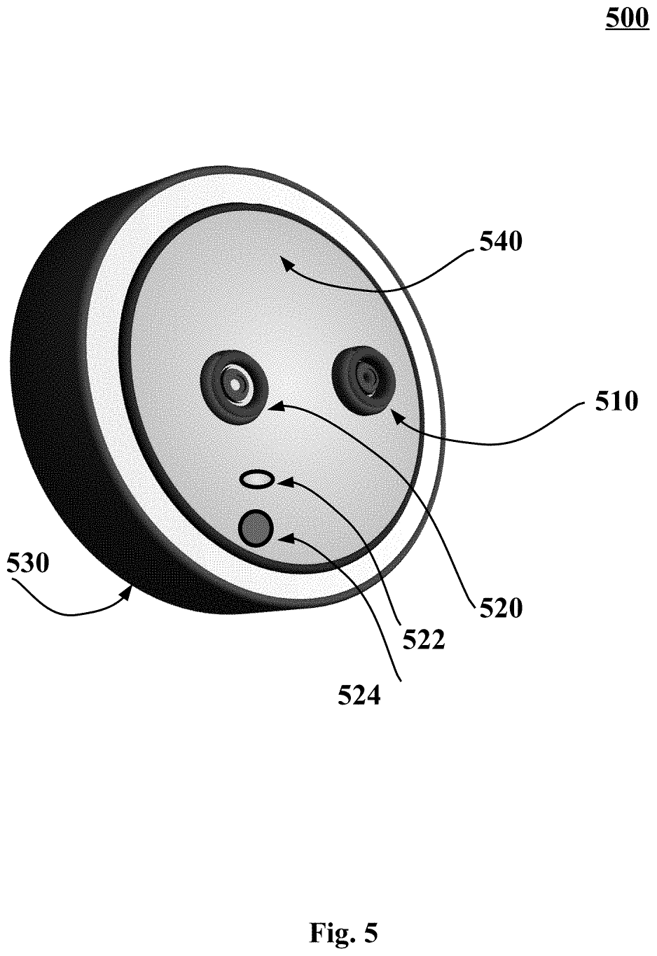

FIG. 5 is a diagram illustrating a perspective view of the pest detector housing 500. A first image sensor 510 is on the right side of the diagram. A second image sensor 520 is on the left side of the diagram. A front panel, also known as a face plate 540, is a component of the outer assembly 530. Sometimes, the pest detector housing 500 can have an optional annunciator 522 and/or an optional visible light device 524 mounts on the front panel. The diagram shown represents an example mechanical housing design for home applications. The illustration further shows a stereophonic pest detector similar in appearance to smoke alarms, making the system and appearance less conspicuous.

In one example, the optional annunciator 522 is an audible signaling device, emitting audible sounds with the frequency components in the 20-20,000 Hz band. In one example, the device is a (1) buzzer; (2) beeper; (3) chime; (4) whistle; or (5) ringer. Buzzers are electromechanical or ceramic-based piezoelectric sounders capable of emitting a high-pitch noise. Sometimes, the sounder emits a single tone or multiple tones in continuous or intermittent operation. In another example, the sounder simulates the voice of a human being or generates music, by using an electronic circuit having a memory for storing the sounds (e.g., music, song, voice message, etc.). The electronic circuit comprises a digital-to-analog converter to reconstruct the electrical representation of the sound and an audio amplifier for driving a loudspeaker, commonly defined as an electro-acoustical transducer that converts an electrical signal to sound. The audible signaling can associate with the pest detection alarm regarding sound volume, type, and steadiness. Some example sounds can simulate the ringing of a telephone set, the buzzer of the entrance bell or the bell sound or a microwave oven. Other examples are a rattling ‘chik-chock’, or “hissing” sound of a rattlesnake and a siren of an emergency vehicle such as a police car, an ambulance, or a fire-engine truck.

In one example, the sound generated is music or song. The elements of the music such as pitch (which governs melody and harmony), rhythm (and its associated concepts tempo, meter, and articulation), dynamics, and the sonic qualities of timbre and texture, can associate with the detection theme. In one example, the annunciator plays human speech. The sound can be a syllable, a word, a phrase, a sentence, a short story, or a long story which is speech synthesized, or pre-recorded. Voices can be male, female, young or old. The text sounded can associate with the detection theme. For example, a detection and identification theme such as ‘scorpion in the room’, ‘scorpion on the wall’, ‘snake on grass’ and ‘spider’ can sound.
A voice, melody or song sounder implementation can comprise a memory storing a digital representation of the pre-recorder or synthesized voice or music, a digital-to-analog (D/A) converter for creating an analog signal, a speaker, and a driver for feeding the speaker. An annunciator which includes a sounder can use a Holtek HT3834 CMOS VLSI Integrated Circuit (IC) named ‘36 Melody Music Generator’ available from Holtek Semiconductor Inc., headquartered in Hsinchu, Taiwan, and described with application circuits in a data sheet Rev. 1.00 dated Nov. 2, 2006, which is incorporated in their entirety. The sounder can use the EPSON 7910 series ‘Multi-Melody IC’ available from Seiko-Epson Corporation, Electronic Devices Marketing Division in Tokyo, Japan, and described with application circuits in a data sheet PF226-04 dated 1998, which is incorporated in their entirety for all as if set forth. A human voice synthesizer can use the Magnevation SpeakJet chip available from Magnevation LLC and described in ‘Natural Speech & Complex Sound Synthesizer’ described in User's Manual Revision 1.0 Jul. 27, 2004, which is incorporated in their entirety for all purposes as if fully set forth herein. Alternatively, the annunciator can use the UM3481 available from Bowin Electronic Company of Fo-Tan, NT, Hong-Kong, described in the datasheet ‘UM3481 Series—UM3481A A Multi-Instrument Melody Generator’ REV.6-03 which is incorporated in its entirety for all purposes as if fully set forth herein.

In the case wherein there are multiple annunciators, the annunciators can be identical or distinct from each other. In one example, the annunciators are of the same type, such as being visual or audible indication type. Alternatively, the annunciators are of the different type, such as one being visual type and the other being audible indication types.

In another case, a Convolutional Neural Network (CNN) can implement a supervised training mode by classifying the static object(s) detected in the visual imagery data to pre-defined labels. In particular, the classifier(s) can identify, and label target static objects depicted in the visual imagery data. Examples of target static objects can comprise scorpions, snakes, and spiders, Training of classifier(s) can use a training image set adapted for the target static object defined for recognition in the imagery and data.

A visit to a public zoo is useful to generate a training image set for pests. The visit enables the viewing of many venomous and non-venomous snakes, scorpions, spiders, and other pests on display. A digital camera can photograph the many species of pests. Several visits to one zoo may be required to build a large sample of images. It can require visits to several zoos, but it is possible without undue experimentation to gain enough photographs to populate a training set. Arachnids populating a training set are further distinguished from insects where they have eight legs and do not have antennae or wings. Training methods can generate the training set required to detect and identify pests. The training image set can improve generalization and avoid over fitting by collecting, constructing, adapting, augmenting and/or transforming to present features of the static objects in various types, sizes, view angles, and/or colors.

One aspect of the design can use a support vector machine (SVM) to classify static object(s) detected in the visual imagery data to predefined labels. Another aspect of the design can use statistical pattern matching to store the results of a plurality of products and plurality of defects, by recognizing thresholds of acceptable minor deviations without flagging errors. In another case, template matching compares captured image pairs with the image of perfect, non-defective image. The system first learns about all the correct attributes of a certain part of the item and then assesses the quality of a produced item according to the estimated standards.

An alternative design can use pattern matching, storing information of both pests, comparing, and contrasting the captured pest pattern versus stored patterns. In another case, feature matching by calculating stereo disparity, identifies the range or depth including visual edges in the stereo image pair. For example: detection of multiple features uses stereo disparity calculates each feature pair determining depth by interpolation. In another case, block matching algorithms for estimating depth from stereo images include dividing each stereo pair of images into pairs of blocks or windows and matching each pair of windows to determine stereo disparity. Matching windows between pairs of stereo images can include determining similarity between the windows. Determining similarity between windows can include block matching using a sum-squared differences equation. Other example methods include using Deep Learning, such as the Keras Deep Learning software. Implementing TensorFlow object detection application programming interfaces is another option. The system can implement statistical pattern matching, storing the results of a plurality of products and plurality of defects to recognize thresholds of acceptable minor deviations without flagging errors.

Depth map estimation techniques use a pair of stereo images and stereo disparity calculations on a pixel-by-pixel basis along epipolar lines passing through both stereo images. Calculating stereo disparity requires comparing each pixel from a first stereo image with the epiline from the second stereo image to determine a match and vice versa. Determining a match can include minimizing a cost or difference function between the pixels. Determining the displacement of a pixel along epipolar lines in stereo images can determine stereo disparity of the pixel. Disparity epipolar geometry, image rectification, calibration techniques and stereo matching strategies are explained in the reference “DISTANCE ESTIMATION FROM STEREO VISION: REVIEW AND RESULTS” Department of the Computer Engineering California State University, Sacramento by Sarmad Khalooq Yaseen which is incorporated by reference. Depth accuracy measurements are shown in the reference “Method for measuring stereo camera depth accuracy based on stereoscopic vision” by Mikko Kytö*, Mikko Nuutinen, Pirkko Oittinen, Aalto University School of Science and Technology, Department of Media Technology, Otaniementie 17, Espoo, Finland which is incorporated by reference.

An example of usage is placing a venomous pest detector in the bedroom of a child or baby. The venomous pest detector monitors against spiders, scorpions, snakes, or other venomous pests entering the room and threatening a child or baby. Another example usage has a non-venomous pest detector in the bedroom of a child or baby. It monitors against mice, rats, cockroaches, and other non-venomous pests entering the room. Another example usage has a pest detector monitoring for all pests, both non-venomous and non-venomous. Another example venomous pest detector usage monitors a swimming pool. The venomous pest detector monitors whether spiders, scorpions, snakes, or other venomous pests enter the pool and pose an unseen threat to swimmers. Another example usage is a venomous pest detector monitoring a garden or periphery of a property outside the home. It is useful to know there are no snakes have entered the property and are not lurking about under lawn furniture or hiding in outdoor storage sheds. It happens from time to time, where an individual encounters such creatures on a property. Another example of usage is a doorbell camera which includes a pest detector to monitor against pests that can slip into a home. The doorbell camera can be a front, side, or rear door. In another case, the doorbell camera has a non-venomous pest detector function. The pest detector can monitor the ventilation ducts, chimneys, and windows of homes to prevent entry of pests. Other examples of a property can include installation in and around a hotel. school, restaurant, camp-ground, pool, port, beach, parking lot, day care center, prison, public building, residential unit, recreational vehicle, office space, mall and hospital and the like.

In some aspects, the detection and removal is for regulatory compliance as can be understood in the assuring the cleanliness of restaurants. In some aspects, insurance companies can require observation in real-time to lower risks of law suits from third party damages. The risk to a claim of wrongful death attributed to a snake bite, or scorpion sting in a hotel, school, day care center or other public location can justify installation of detection systems for insurance policy compliance. In some aspects, the pest can be a crocodile, alligator, wolf, lion, mountain lion, bear or other dangerous animal.

Examples of venomous snakes include: (1) southern copperhead (agkistrodon contortrix contortrix); (2) cottonmouth or “water moccasin” (agkistrodon piscivorus); (3) imber rattlesnake (Crotalus horridus); (4) Dusky pygmy rattlesnake (Sistrurus miliarius barbouri); (5) Eastern diamondback (Crotalus adamanteus); (6) Eastern coral snake (Micrurus fulvius); (7) and Burmese pythons which have invaded Florida.

The present disclosure uses flowchart illustrations, also referred to as flow diagrams and/or block diagrams of methods, apparatus (systems) and computer program products. Computer program instruction code can implement or support each block of the flowchart illustrations, and/or block diagrams, and combinations of blocks in the flowchart illustrations. Computer program instruction code executes on a processor of a general-purpose computer, special purpose computer, or other programmable data processing apparatus to produce a machine, such that the instruction code, which execute via the processor of the computer or other programmable data processing apparatus, create means for implementing the functions/acts specified in the flowchart, flow diagram, and/or block diagram block or blocks.

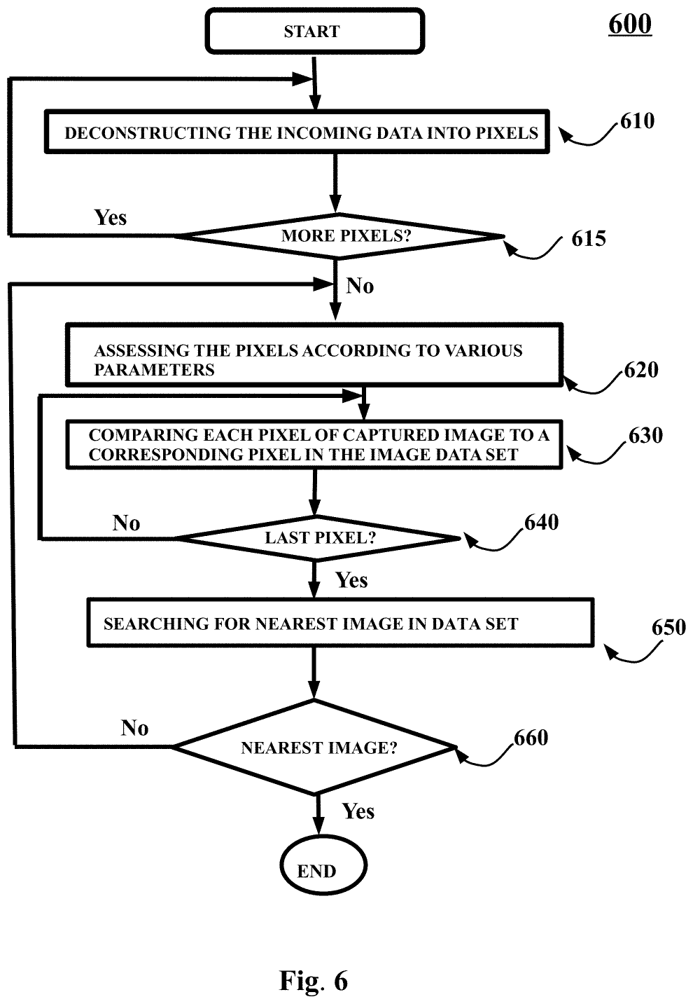

Referring now to FIG. 6, a flow diagram 600 illustrates an example method of detecting pests using an image processing software algorithm. A first step of the flow diagram deconstructs the incoming visual data into pixels and parses incoming pixels for generating structures of rows, columns, or frames of video data. (step 610). Next, check if more pixels are incoming for the structure (step 615). If the check does not receive the last pixel of the structure, the method returns to step 610. If it is the last pixel of the structure, the method continues to assess the pixels according to various parameters in step 620. In the following step, the method is comparing each pixel to a corresponding pixel in the images data set (step 630). Comparing pixels continues until the last pixel. This last pixel can be the last pixel of a frame, row, line or other given quantity in a data structure. A first check counts to determine if it reaches the last pixel (step 640). If it is not the last pixel, the method returns to step 610. If it is the last pixel, the method continues to validate the prediction by searching for the nearest image in the data set (step 650). A second method check determines if the method finds the nearest image (step 660). According to one case, the method iterates a finite number of loops through the image data set using a programmable value for the loop value. If it does not find the nearest image (step 660), the method returns to step 620 iterating searches and finding the nearest image in the data set. The method ends when validating a match.

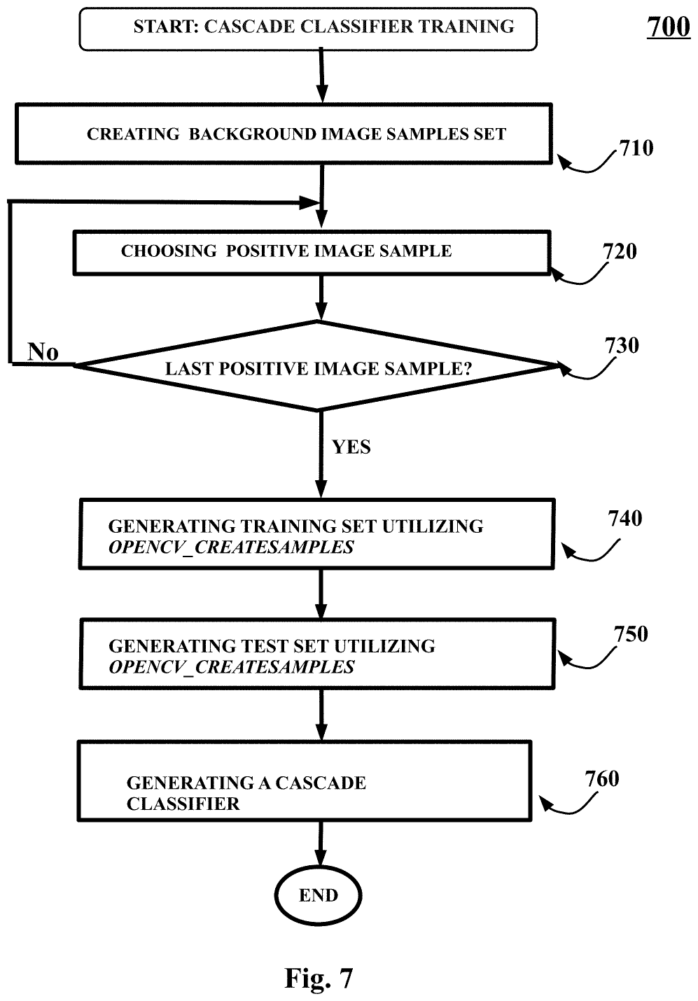

Referring now to FIG. 7, a flow diagram 700 illustrates a cascade-classifier training using OpenCV. A first step of the flow diagram creates a set of background image samples (step 710). The image samples set comprises a text file corresponding to a JPEG image for each line of the text file. A file directory stores a set of background images pointed to by the image samples text file. A design aim is for the background image sample size to be greater than a training window size. Next, select a positive image in step (720). The method selects a positive image made from a venomous pest: such as a scorpion, snake, spider, and/or a non-venomous pest such as a mouse, rat, cockroach. Next, check for the last positive image (step 730). If it is not the last positive image, the flow diagram returns to step 720. If it is the last positive image, the flow diagram continues to the creation and generation of a training set by execution of the opencv_createsamples utility in step 740. In this step, use programmable arguments to generate a training set of PNG format images. The programmable arguments enlarge the set of positive samples of objects by rotating each sample object randomly. These rotations increase variations of the light intensity of pixels for threshold by height, width, and background-color. Therefore, rotation angles of the sample objects in the x, y, and z directions are used to enlarge the set. Multiplication of each positive image by substantial permutations increases the positive image data set. The range of randomness and number of permutations is programmable by the arguments. Next, the opencv_createsamples utility generates a test set of JPEG format images using the specific training set arguments (step 750). Next, the Cascade Training uses the opencv_trainscascade application to generate the classifiers in step 760 and thereafter the flow diagram for cascade classifier training ENDs.

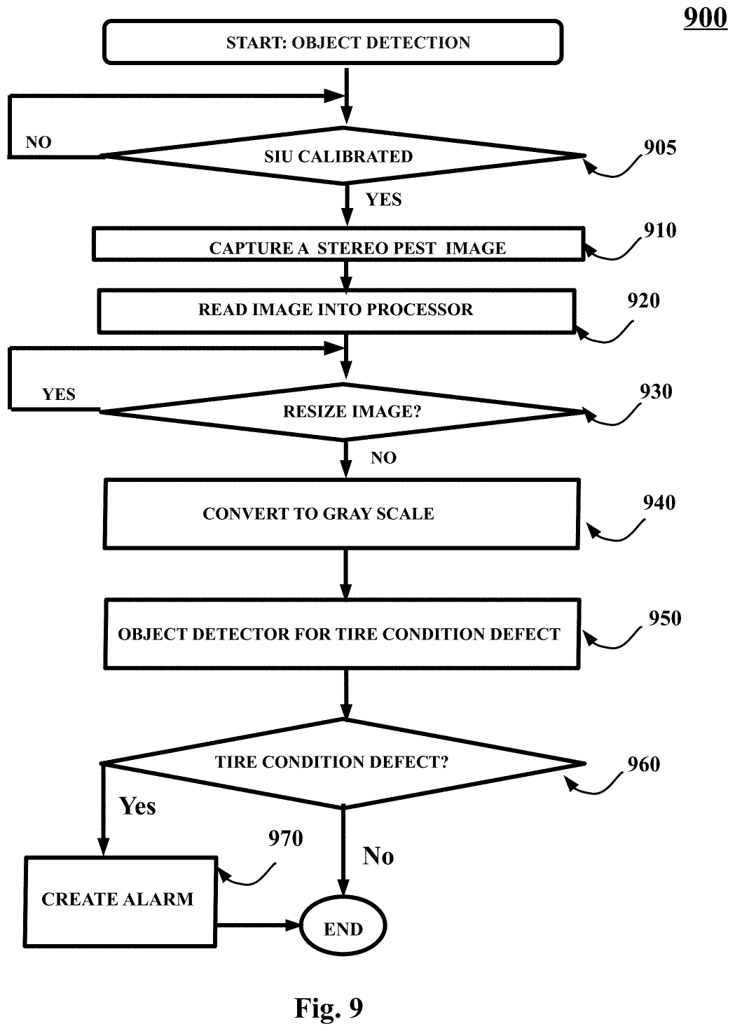

Referring now to FIG. 9, the flow diagram 900 shows an object detection method. The first step checks the SIU calibration status (step 905), If not, the method returns to the step 900 and performs a calibration. If calibrated, the method continues to step 910 and captures a stereo pest image. The image is then read into a processor in step 920. A second check then determines if the image requires resizing (step 930). If it the image does requires resizing, the flow diagram returns to step 920 and loops until verifying the correct image. If not, the flow diagram continues to convert the image to gray scale (step 940). Then, the object detector for a pest detection executes, If yes, the method captures a stereo pest image (step 950). The flow diagram then executes a third check for the detection of a pest (step 960). If a pest condition exists, the flow diagram continues to create an alarm (970). If not, the method ends.

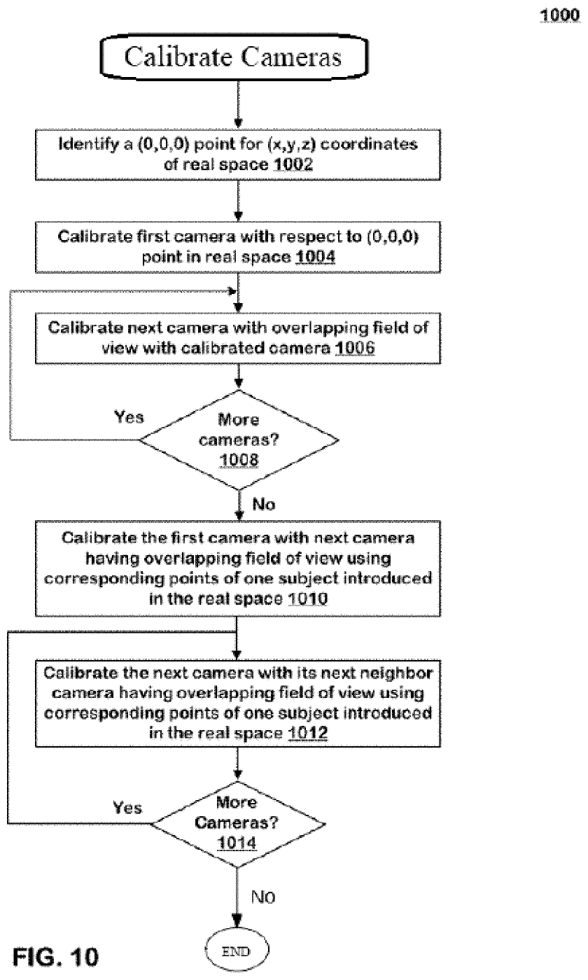

FIG. 10 shows a flowchart 1000 illustrating a calibration process. The calibration process starts at step 1002 by identifying a (0, 0, 0) point for (x, y, z) coordinates of the real space. At step 1004, a first camera with the location (0, 0, 0) in its field of view is calibrated. At step 1006, a next camera with overlapping field of view with the first camera is calibrated. At step 1008, it is checked whether there are more cameras to calibrate. The process is repeated at step 1006 until all cameras are calibrated. In a next process step 1010, a pest subject is introduced in the real space to identify conjugate pairs of corresponding points between cameras with overlapping fields of view. The process is repeated for every pair of overlapping cameras at step 1012. A check is made at step 1014 if more cameras, image sensors, require calibration. The decision at step 1014 either loops back to step 1012, or the calibration process ends.

What is claimed is:

1. An apparatus, comprising:
a stereoscopic imaging unit (SIU) to capture a pest image;
an image processing code operative to process the pest image;
an image processor and hardware control unit (IPHWCU) to store and run a program instruction code and the image processing code, wherein the program instruction code provides software interface drivers to communicate with the SIU, communications circuits; and
an alarm notification operative to generate a pest removal action from a property.

2. The apparatus according to claim 1, wherein the pest removal action is a professional pest removal service.

3. The apparatus according to claim 1, wherein the apparatus is a Smart Home apparatus.

4. The apparatus according to claim 1, wherein the pest is a venomous pest selected from the group consisting of snakes, spiders, centipedes, lizards and scorpions.

5. The apparatus according to claim 3, further comprising a 5G radio frequency (RF) communications unit coupled to the image processor and hardware control unit and operative to communicate with an external network for the alarm notification.

6. The apparatus according to claim 1, wherein the pest is selected from a group consisting of a crocodile, alligator, wolf, lion, mountain lion, and bear.

7. The apparatus according to claim 1, wherein the property is selected from a group consisting of a hotel, school, restaurant, camp-ground, pool, port, beach, parking lot, day care center, prison, public building, residential unit, recreational vehicles, office space, and hospital.

8. The apparatus according to claim 7, further comprising a movable mounting mechanism to aim the stereoscopic imaging unit towards regions of interest on the property.

9. The apparatus according to claim 1, further comprising IP67 compliance for outdoor operation and water resistance.

10. A method of imaging and detecting pests on a property comprising the steps of:
capturing a stereo image;
processing the stereo mage;
detecting a pest in the stereo image; and
generating an alarm to create a removal action of the pest from a property.

11. The method of claim 10, wherein the alarm is for regulatory safety and health compliance.

12. The method of claim 10, wherein the alarm notifies an insurance company for safety and insurance policy compliance.

13. The method of claim 10, wherein the property is a member selected from the group consisting of a hotel. school, restaurant, camp-ground, pool, port, beach, parking lot, day care center, prison, public building, residential unit, recreational vehicle, office space, mall and hospital.

14. The method of claim 13, wherein the pest is venomous.

15. The method of claim 13, wherein the pest is non venomous.

16. The method of claim 13, wherein the alarm wherein the alarm comprises audible messages.

17. The method of claim 13, wherein the alarm is sent via a cellular phone device.

18. The method of claim 17, wherein the wherein the alarm is sent via an email.

19. The method of claim 13, wherein the alarm comprises visible alerts.

20. The method of claim 13, wherein no alarm creates a safety message to enter an area within a property.
